(19) United States
(12) Patent Application Publication
(10) Pub. No.: US 2023/0009435 A1
(43) Pub. Date: Jan. 12, 2023

(54) SYSTEMS AND METHODS FOR SIGNAL PATH ISOLATION FOR NEUTRAL-HOST HARDWARE

(71) Applicant: CommScope Technologies LLC, Hickory, NC (US)

(72) Inventor: Johannes Steigert, Harburg (DE)

(73) Assignee: CommScope Technologies LLC, Hickory, NC (US)

(21) Appl. No.: 17/859,898

(22) Filed: Jul. 7, 2022

Related U.S. Application Data
(60) Provisional application No. 63/220,808, filed on Jul. 12, 2021.

(51) Int. Cl. H04B 1/525; H04B 1/58; H04B 1/10

(52) U.S. Cl. CPC H04B 1/525; H04B 1/58; H04B 1/1036; H04B 2001/1045; H04B 2001/1072

(57) ABSTRACT

Systems and methods for signal path isolation for neutral-host hardware are provided. In one embodiment, an isolation circuit for a multiple-subchannel wireless communication transceiver comprises: a Tx path coupled to a transmit path output of a multiple-subchannel transceiver; a Rx path coupled to a receive path input of the transceiver; a precancellation circuit comprising: an isolation adjustment circuit within the transmit path of the isolation circuit, the isolation adjustment circuit comprising a phase shifter and a reflection tuner; a directional coupler within the Rx path of the isolation circuit. The isolation adjustment circuit outputs a reflected wave signal comprising a cancellation reference signal to the directional coupler. The cancellation reference signal comprises a complex conjugate of a TX signal leakage signal component of a signal transported in the Rx path of the isolation circuit. Within the directional coupler the cancellation reference signal destructively interferes with TX signal leakage signal component.

### CROSS-REFERENCE TO RELATED APPLICATIONS

This application claims priority to U.S. Provisional Application Ser. No. 63/220,808, same title herewith, filed on Jul. 12, 2021, which is incorporated in its entirety herein by reference.

### BACKGROUND

In the past, mobile network operators (MNO) each maintained separate communications equipment and systems in order to provide network coverage to their respective customers. Over time, especially in urban areas as well as in large enterprises and venues, it has become increasingly difficult for each MNO to deploy their own dedicated communication hardware due to lack of space. At the same time, the increasing growth of data traffic puts MNOs under considerable pressure to continuously improve the corresponding network infrastructure used to provide their services.

As a consequence, shared communication hardware (referred to herein as neutral-host hardware), has gained interest with MNOs for economic, ecological, and other practical reasons. From a technical perspective, neutral-host base stations integrate transceivers for each operator into a common hardware. State-of-the-art neutral-host hardware commonly can support frequency-domain duplex (FDD) communication bands with this approach, which comes with an acceptable complexity but is limited to pre-defined MNO configurations.

For time-domain duplex (TDD) communication bands, the neutral-host approach is more complex. This is because the switching points for alternating between Downlink (DL) mode and Uplink (UL) mode for each MNO are synchronized very precisely. When only one MNO is utilizing network communication hardware, such as a transceiver, synchronized switching points of the MNO enable isolation of the receive path from undesired transmit signal leakage by deactivating power amplifiers and utilization of radio frequency (RF) switches during uplink timeframes to provide further isolation from the transmitter lineup through. However, this is not the case though when multiple MNOs are sharing the network communication hardware. For example, there is no coordination between the multiple MNOs with respect to their respective switching between downlink (DL) mode (transmit mode) and Uplink (UL) mode (receive mode). As a result, the present configuration of UL verse DL mode for the subchannels of the neutral host at any one time could be completely arbitrary. That is, there is no synchronization of switching points between the multiple MNOs. The power amplifiers therefore cannot be disabled to provide isolation of transmit signal leakage when a subchannel is actively receiving because another subchannel may be using the power amplifier for transmitting at the same time. As an example, the 5G New Radio Band (5G NR) N78, can be split into 4 bands where a first MNO has the first 100 MHz, a second MNO has the second 100 MHz and so on. The first MNO operator can be in a transmit mode in the first 100 MHz band while a second MNO is using the 2^{nd} 100 MHz band in a receive mode. Current state-of-the-art techniques to improve isolation therefore are therefore limited in their application to neutral-host hardware.

### SUMMARY

The Embodiments of the present disclosure provide systems and methods for signal path isolation for neutral-host hardware and will be understood by reading and studying the following specification.

In one embodiment, an isolation circuit for a multiple-subchannel wireless communication transceiver comprises: a transmit (Tx) path coupled to a transmit path output of a multiple-subchannel transceiver; a receive (Rx) path coupled to a receive path input of the multiple-subchannel transceiver; a precancellation circuit comprising: an isolation adjustment circuit comprised within the transmit path of the isolation circuit, the isolation adjustment circuit comprising a phase shifter and a reflection tuner; a directional coupler comprised within the Rx path of the isolation circuit; wherein the isolation adjustment circuit outputs a reflected wave signal comprising a cancellation reference signal to the directional coupler, wherein the cancellation reference signal comprises a complex conjugate of a TX signal leakage signal component of a received RF signal transported in the Rx path of the isolation circuit, wherein within the directional coupler the cancellation reference signal destructively interferes with TX signal leakage signal component.

### DRAWINGS

Embodiments of the present disclosure can be more easily understood and further advantages and uses thereof more readily apparent, when considered in view of the description of the preferred embodiments and the following figures in which:

FIGS. 1 and 1A are block diagrams illustrating an example isolation stage circuit embodiment.

FIGS. 2, 3 and 4 are plots illustrating cancellation performance for an example precancellation circuit embodiment.

FIG. 5 is a block diagram that illustrates an example interface circuit for coupling a hybrid cancellation filter to a precancellation circuit.

FIG. 6 is a block diagram that illustrates a digital realization of an example hybrid cancellation filter embodiment.

FIGS. 7 and 7A are block diagrams illustrating an example integration of a hybrid cancellation filter with a precancellation circuit.

FIG. 8 is a flow chart illustrating an example method embodiment for calibrating a precancellation circuit.

FIG. 9 is a flow chart illustrating an example method embodiment of for updating setpoint values for cascading isolation stages in operation

FIG. 10 is a graph depicting power verses subchannel for cascading isolation stages for an example RF band.

FIG. 11 is a block diagram illustrating and example embodiment of a multiple-subchannel wireless transceiver in combination with cascading isolation stages.

In accordance with common practice, the various described features are not drawn to scale but are drawn to emphasize features relevant to the present disclosure. Reference characters denote like elements throughout figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

Embodiments of the present disclosure embodiments for providing high isolation between the transmit and receive paths of multiple operator/multiple subchannel wireless communications transceivers such as neutral-host wireless communications base stations, distributed antenna systems, repeaters, or any other transceiver equipment, by utilizing cascading isolation stages. It should be understood that an underlying isolation mechanism that may be present in a transceiver is the Adjacent Channel Leakage Ratio (ACLR) set forth in mobile communications standards. Signal reception in a neutral-host TDD system benefits from the fact that the receiver (Rx) in receiving a signal on a given subchannel may not always need to be protected from a high-power transmit (Tx) signals at the same subchannel. However, high-power Tx signals in adjacent subchannels can still result in Rx path saturation effects, hence desensitization. With ACLR, related desensitization of neighboring Rx subchannels caused by active transmissions in Tx subchannels is well predictable. For example, the ACLR standard states that for LTE and 5G NR applications, leakage from transmissions in one subchannel should be attenuated at least 45 dB in the adjacent subchannel.

That said, in practice an inter sub-band isolation of 45 dB is not sufficient to avoid an impact on the signal reception in neighbored sub-bands and isolation of more than 100 dB is more often appropriate in the case of a multiple MNO neutral-host TDD system. With the embodiments presented herein, the desired levels of isolation, which in typical systems would be introduced by RF switches and power amplifier deactivation, is instead achieved by cancellation stages appended to the Tx and Rx paths of wireless RF transceivers.

As the term is used herein, a RF band refers to a range of frequencies in the RF spectrum, the frequencies typically defined by a regulation authority or industry standard. The RF band may be channelized, meaning that certain (usually evenly spaced) frequencies within the RF band are designated as carrier frequencies with RF signals transmitted within a strictly defined bandwidth of the transmitted signal on each side of a carrier frequency. These subdivisions of a RF band may each be synonymously referred to as a “sub-band” or “sub-channel” within the RF band, it would be understood by those skilled in the art that a sub-band (or sub-channel) may also be referred to as a “channel” in the sense of a medium for the purposes of carrying a RF signal. As an example, the 5G NR N78 band is a standards defined 400 MHz band that can be divided into e.g. four independent sub-bands (or subchannels) of 100 MHz each, each of which can serve as a channel for carrying the communications signals of a respective MNO. Accordingly, a “multiple-subchannel wireless transceiver” as the term is used in this disclosure refers to radio receiving equipment tuned to operate in a given RF band, which can independently transmit and receive signals on multiple sub-bands (or subchannels) within that RF band.

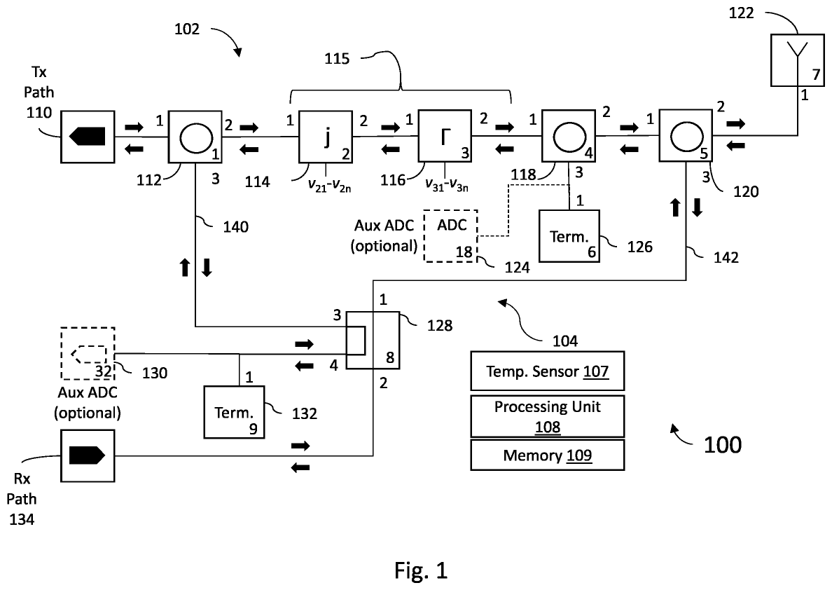

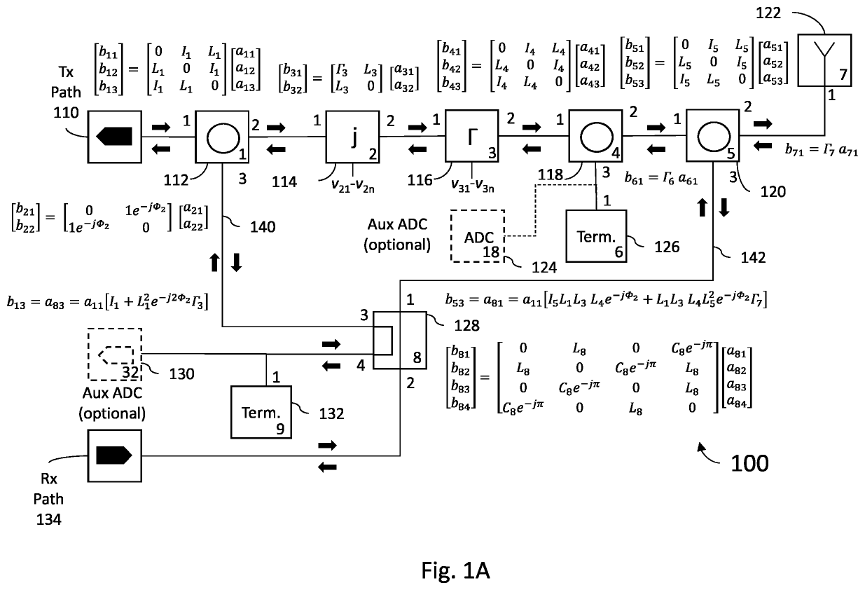

FIG. 1 is a block diagram illustrating an example isolation stage circuit 100 embodiment for use with an in-band neutral-host transceiver. This isolation stage circuit 100 is also referred to herein as the “precancellation circuit 100”. Precancellation circuit 100 functions to provide further isolation between Tx and Rx paths of the neutral-host transceiver circuitry to which it is coupled to, beyond the 45 dB of ACLR. As shown in FIG. 1, the precancellation circuit 100 comprises a transmit path 102 that is coupled to an Tx path output 110 of a transceiver. The transmit path 102 of the precancellation circuit 100 itself comprises a first circulator 112, a phase shifter 114, a reflection tuner 116, a circulator 118 (referred to herein as an Aux circulator) and a circulator 120 (referred to herein as an antenna circulator) and in this embodiment, an antenna 122. As will be discussed in greater detail below, the phase shifter 114 and a reflection tuner 116 together define an isolation adjustment circuit 115. As the term is used herein, a circulator is an RF device, typically a ferromagnetic device, used to regulate RF signal flow within a circuit by transmitting input signals received at a port in one direction around the circulator to the next port, and exhibiting high signal isolation that inhibits input signals from propagating to a port in the opposite direction around the circulator. The phase shifter 114 may comprise one or more integrated circuits (ICs) or a discrete circuit. For example, the phase shifter 114 may comprise tunable capacitors, diodes, and/or hybrid-coupler, at least covering a phase dynamic range of: ϕ₁(ν₂₁, . . . , ν₂₁)=±180°. Similarly, the reflection tuner 116 can be an IC, or comprise a digitally tunable capacitor and/or tunable inductor circuit in T, Pi, or other advanced circuit configurations. To allow for a sufficient cancellation dynamic range, the reflection tuner should be able to provide a reflection coefficient of at least:

$${Γ}_{3} ( {v}_{31} , … , {v}_{3 n} ) = {Γ}_{7 , max} = \frac{{Γ}_{5} {Γ}_{8}}{{Γ}_{3} {C}_{8} {e}^{- j π}} .$$

In some embodiments, the second circulator (or AUX circulator) 118 prior to the antenna circulator 122 which may be utilized to tap into the transmit path 102 to measure signals traversing the transmit path 102 for various purposes, as described below. For embodiments where the AUX circulator 118 is present but not being utilized to tap into the transmit path 102, a termination circuit 126 may be coupled to any unused port(s).

The precancellation circuit 100 also comprises a receive path 104 that is coupled to an Rx path input 134 of the transceiver. The receive path 104 of the precancellation circuit 100 comprises a directional coupler 128 coupled to receive a cancellation reference signal 140 output from the first circulator 112 and also input a received RF signal 142 that is output from the antenna circulator 120. The received RF signal 142 as output from the antenna circulator 120 comprises the composite of: 1) any RF wireless radio signal received by the antenna 122; 2) any TX signal leakage of transmit path 102 signals that occurs through the antenna circulator 120; and 3) any reflection of transmit path 102 signals that reflect back from the system output, i.e. antenna 122 into the antenna circulator 120. A first output from the directional coupler 128 (at port 2) is provided to the input of the transceiver RX path 134 and comprises received RF signal 142 as purified by the cancellation reference signal 140. In some embodiments, the directional coupler 128 comprises a second output which may be utilized to tap in and measure signals traversing the receive path 104 for various purposes, as described below. For embodiments where the second output is present but not being utilized, a termination circuit 132 may be coupled to that unused port.

In the absence of the cancellation provided by the precancellation circuit 100 described herein, a high Tx noise floor output by the Tx path 102 can drastically limit signal reception in one or more Rx path 104 sub-bands even when the leakage from neighboring subchannels is lower than the defined ACLR limit. The precancellation circuit 100 described herein therefore functions to manage and suppress Tx path 102 noise leaking into the Rx path 104.

In FIG. 1A, precancellation circuit 100 and its components are again illustrated, further including related signal flow diagrams and scattering matrices to illustrate the baseline functional principles of the technique. In FIG. 1A, the elements of the precancellation circuit 100 are also relabeled for clarity with individual component numbers better suited for explaining the scattering matrices and travelling waves. The individual component numbers are indicated on the lower right inside of each element while component port numbers are shown adjacent to the element next to the respective port. With respect to the traveling waves, the depicted signal nomenclature uses the letter “a” for a forward traveling wave (i.e., a wave entering a port of a component) and the letter “b” for a reverse traveling wave (i.e., a wave as emitted from a port of a component). The letters “a” and “b” are indexed using two numbers. The first number stands for the individual component number, while the latter represents the dedicated component port. For example, the forward traveling wave received from the Tx path 110 at the port 1 of first circulator 112 would be labeled “a₁₁”. The reverse traveling wave exiting from port 1 of first circulator 112 would be labeled “b₁₁”. The forward traveling wave received from the first circulator 112 at the port 1 of phase shifter 114 would be labeled “a₂₁”. The reverse traveling wave exiting from port 1 of phase shifter 114 would be labeled “b₂₁”. It should be understood that for series connected elements, a reverse traveling wave exiting one element is the same wave as the forward traveling wave entering the next element. For example, the labels a₁₂ and b₂₁ both refer to the same traveling wave propagating from phase shifter 114 port 1 to first circulator 112 port 2. With respect to further nomenclature, “Lₙ” indicates the insertion loss (measured in dB) at the ports of a component while “Iₙ” is the isolation coefficient, “Cₙ” is the coupling coefficient, and Γₙ is the reflection coefficient (each measured in dB). For the corresponding calculus, the parameters Lₙ, Iₙ, Cₙ, Γₙ denote the magnitudes (linear expression) of complex values. The term Φ₂ indicates the variable phase shift introduced by phase shifter 114. Both the phase shifter 114 and reflection tuner 116 are adjustable using respective voltages v₂₁-v₂ₙ and v₃₁-v₃ₘ controlled, for example, by a processing unit 108 such as a field programable gate array (FPGA), Central Processing Unit (CPU) or other controller. For the sake of brevity, it is assumed that all components are ideally matched to the system impedance and are simplified according to the entries in their scattering matrix if not stated otherwise.

Considering the circuit diagram in FIG. 1A, the ratio b₈₂:a₁₁ can be seen to directly relate to the Tx to Rx suppression (or in other words cancellation) as observed at the Rx input 134. This may be expressed as:

$$C = 20 log ( \frac{{b}_{82}}{{a}_{11}} ) .$$

Taking the given scattering matrices into account, the cancellation at port 2 of the directional coupler 128 can be expressed as:

$$\frac{{b}_{82}}{{a}_{11}} = {L}_{t} [ {I}_{5} + {L}_{5}^{2} {Γ}_{7} ] + {C}_{8} {e}^{- j π} [ {I}_{1} + {L}_{1}^{2} {e}^{- j 2 {Φ}_{1}} {Γ}_{3} ]$$

where the Lt is a factor that represents the wave propagation on through the transmit path 102 up to the antenna 122. This can be expressed as: Lₜ=L₁L₃L₄L₈ₑ^{-jΦ1}. Given the above mentioned components of the receive signal 142 as output from the antenna circulator 120 (wave b₅₃ in FIG. 1A) the reflection of transmit path 102 signals that reflect back from the antenna 122 due to Γ₇ can be utilized to set boundary case considerations to identify parameter settings for providing cancellation.

A first boundary condition can be set for the case where Γ₇=0, which would occur when the antenna 122 is ideally impedance matched to the Tx path 102. When Γ₇=0, the cancellation C converges to a maximum when:

C₈e^{-jπ}[I₁+L₁²e^{-j2Φ1}Γ₃]=(LₜI₅)⁺ Eq. (1)

where the operator “*” denotes complex conjugate.

Three sub-boundary conditions can be set for the case where Γ₇ 0. For the case where Γ₇≤C₈, the cancellation C converges to a maximum when:

C₈e^{-jπ}[I₁+L₁²e_{-j2Φ1}Γ₃]=(Lₜ[I₅+L₅²Γ₇])⁺ Eq. (2.1)

For the Γ₇ 0 case where

$${Γ}_{7} = \frac{{I}_{5}^{*}}{{L}_{5}^{2}} \sim {I}_{5}^{*} ,$$

the cancellation C of Eq. 2.1 converges to a maximum when:

$${Γ}_{3} {e}^{- j 2 {Φ}_{1}} = \frac{{I}_{1}^{*}}{{L}_{1}^{2}} \sim {I}_{2}^{*} \qquad Eq . ( 2.2 )$$

It should be noted that this specific case is unlikely to occur with practical applications since the isolation of circulators also exhibits a certain frequency dependence and antennas usually tend to have non-neglectable reflection coefficients. This taken into account, one can find that the isolation I₂⁺ outnumbers the reflection factor magnitude Γ₃ with a very high probability in an practical environment.

For the Γ₇ 0 case where case where Γ₇>C₈, it should be noted that the cancellation dynamic range is limited by the coupling factor of C₈ since it has an direct impact on the magnitude of the modified leakage signal and its ability to cancel out the Tx signal portion leaking from the antenna 122 port into the Rx path 104. However, the isolation adjustment circuit 115 can be adjusted to minimize impact on given intrinsic circulator isolation reflection at the antenna port (port 2 of the antenna circulator 120).

In each case, precancellation is obtained by solving for the Φ₂ and Γ₃ that maximize cancellation in the above equations and then adjusting the isolation adjustment circuit 115 (i.e., Φ₂ of phase shifter 144 and Γ₃ of reflection tuner 116) so that within the directional coupler 128, the cancellation reference signal 140 attenuates the components of the received RF signal 142 comprising: 1) the TX signal leakage of transmit path 102 signals that occurs through the antenna circulator 120, and 2) TX signal leakage comprising reflection of transmit path 102 signals that reflect back from the antenna 122 into the antenna circulator 120. More specifically, when the cancellation reference signal 140 and the undesirable TX signal leakage plus antenna reflection components are complex conjugates, then destructive interference occurs within the directional coupler 128 substantially attenuates those components from the output port 2 of the directional coupler 128.

It should be understood that when solving for the values of Φ₂ and Γ₃, the values of the other parameters in the above equations would be known, for example from device datasheets, manufacturer supplied curves or tables, direct measurements, or from other sources. The C, L and Γ₇ parameters vary as a function of signal frequency and therefore would be selected based on the frequency of the Rx subchannel where precancellation attenuation is to be applied. The value of Φ₂ and Γ₃ may therefore be precalculated for each potential combination of channels operating in Rx and Tx mode and stored in a memory 109. As the subchannels supported by the neutral-host hardware each independently shift between Rx and Tx modes, the processing unit 108 can correlate the configuration to the corresponding Φ₂ and Γ₃ settings, and adjust the 02 and Γ₃ settings based on the prerecorded values for the present mode configuration.

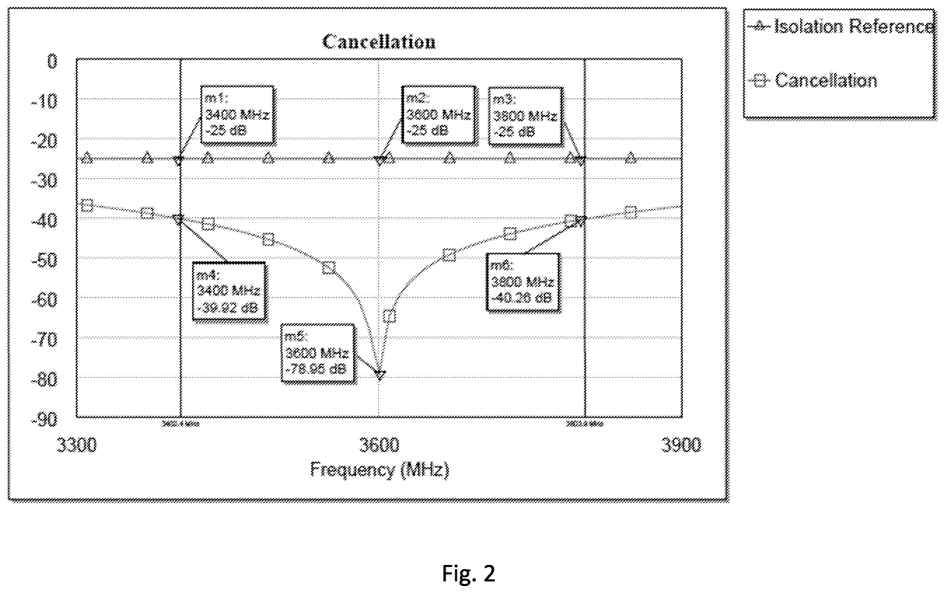

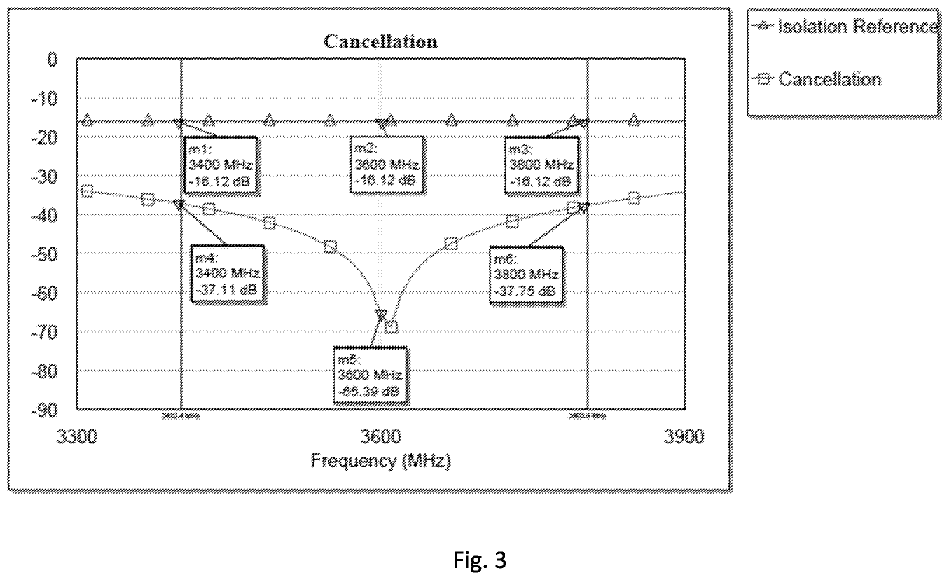

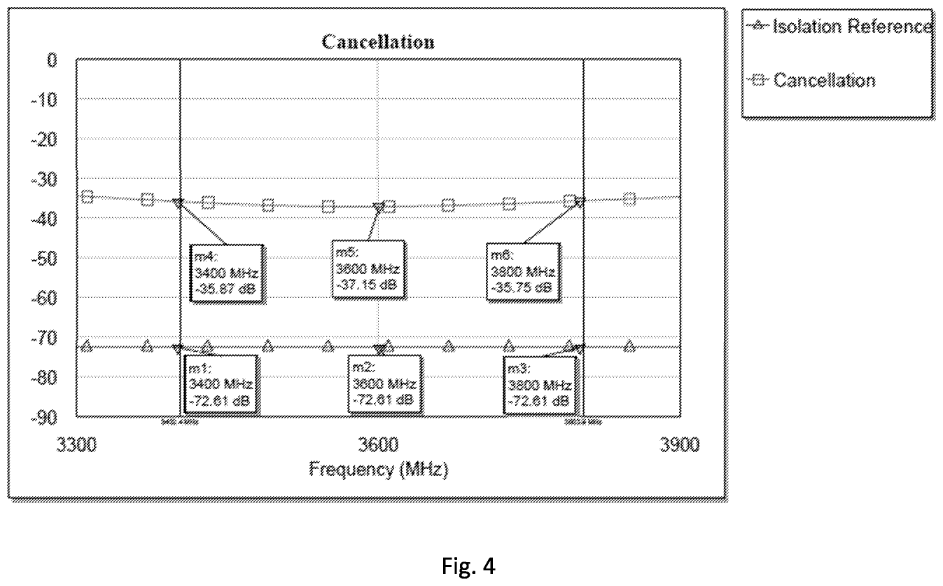

FIGS. 2, 3 and 4 each depict example simulation results for the above discussed cases in a typical scenario for a subchannel frequency of 3600 MHz in the n47 5G NR frequency band using a circulator with an isolation of:

$${I}_{1 , 4 , 5} = {10}^{\frac{- 25 d B}{20}} ,$$

an insertion loss of

$${L}_{1 , 3 , 4 , 5 , 8} = {10}^{\frac{0 d B}{20}} ,$$

and a directional coupler with

$${C}_{8} = 1 {0}^{\frac{4 d B}{20}} .$$

In addition to the cancellation performance of the precancellation circuit 100, the results depict the generic isolation of a generic circulator which can be seen as reference. From the simulation results in FIGS. 2, 3 and 4 it is noted that precancellation circuit 100 provides significant cancellation performance at the selected 3600 MHz subchannel frequency. Compared to other techniques, precancellation circuit 100 furthermore adds negligible insertion loss and Noise Figure to the transceiver Rx path 134 and provides a robust cancellation. In some embodiments, the processing unit 108 may further utilize temperature measurements from a sensor 107 to temperature compensate the voltages applied to the isolation adjustment circuit 115 to control Φ₂ and Γ₃ for better precision in adjusting those parameters.

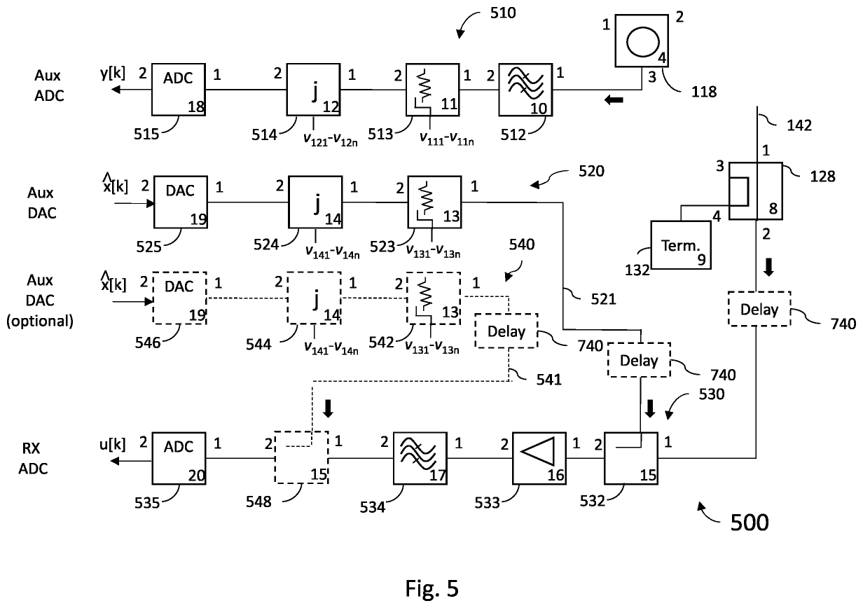

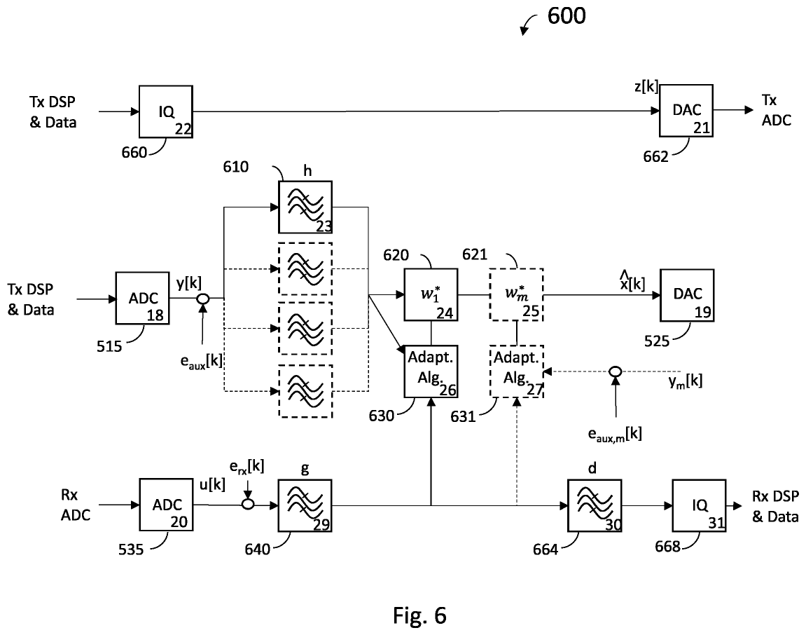

FIGS. 5 and 6 illustrate example embodiments of an optional hybrid cancellation filter that may be used in conjunction with, or independent of, the precancellation circuit 100 discussed above. More specifically, FIG. 5 illustrates an interface circuit 500 for coupling the hybrid cancellation filter 600 of FIG. 6 to the precancellation circuit 100. Besides the aforementioned precancellation of the Tx noise in Rx sub-bands leaking into the Rx path 134, it can be beneficial to also cancel strong Tx signals in neighbored channels using the hybrid cancellation filter 600 since those strong Tx signals can cause severe desensitization and nonlinear saturation effects in the transceiver Rx path 134.

Interface circuit 500 shown in FIG. 5 comprises three signal paths, an Aux ADC path 510, an Aux DAC path 520, and an RX signal path 530.

The Aux ADC path 510 is coupled to the port 3 of Aux circulator 118 to tap into the transmit path 102 to measure signals traversing the transmit path 102. The Aux ADC path 510 comprises an RF bandpass filter 512, an attenuator 513 and phase shifter 514, and ADC 515. Aux ADC path 510 outputs digitized reference signal y[k] to the hybrid cancellation filter 600. The Rx ADC path 530 comprises a directional coupler 532 coupled to the output of the directional coupler 128 to input the received RF signal 142 after application of the cancellation reference signal 140 to the received RF signal 142. Rx ADC path 530 comprises a low noise amplifier (LNA) 533, an RF bandpass filter 534, and ADC 535.

The Aux DAC path 520 is coupled to the directional coupler 532 to insert into the received RF signal 142 a hybrid cancellation signal 521 produced by the hybrid cancellation filter 600. Aux DAC path 520 comprises an attenuator 523, phase shifter 524, and DAC 525. Aux DAC path 520 receives a digitized hybrid cancellation signal \hat{x}[k] from the hybrid cancellation filter 600 and outputs the hybrid cancellation signal 521 to the Rx ADC path 530.

The adjustable phase shifter 514 and attenuator 513 in the Aux ADC path 510, and the adjustable phase shifter 524 and attenuator 523 in the Aux DAC path 520 are utilized to adjust the signal leveling (in both phase and attenuation) in those respective paths in order to optimize the usage of the ADC 515 and ADC 535, and the DAC 525, with respect to dynamic range and also to fine tune (e.g. maximize to the degree possible) cancellation. The phase shifters and attenuators are controlled by a processing unit 108 by adjusting corresponding voltages v₁₁₁-v₁₁ₙ, V₁₂₁-v₁₂ₙ, v₁₃₁-v₁₃ₙ and v₁₄₁-v₁₄ₙ or using a digital bus like I2C or SPI for example. The phase shifters and attenuators can be either an IC or comprise discrete circuits. The hybrid cancellation signal 521 is fed into the Rx path before the LNA 533 (or optionally elsewhere before the ADC 535) using direction directional coupler 532. The RF filter 534 is configured to filter noise and jammers from the Rx signal outside the presently assigned communication band. The RF filter 512 is similarly configured to filter noise and jammers from the circulator 118 outside the presently received RF band so that the digitized reference signal y[k] is tuned to pass the same RF band. The RF filters are dynamically adjustable by the processing unit 108 to respond to adjust the passbands as the subchannels switch between Tx and Rx modes. In some embodiments, memory 109 comprises a look-up table indicating to the processing unit 108 the settings for RF filters for the present Tx/Rx subchannel mode. In some cases, the RF filters operate in a fixed frequency band which relates to the assigned communication bands to filter noise and jammers outside the assigned frequency band.

Referring to FIG. 6, the digitized reference signal y[k] from the Aux ADC path 510 provides one input into hybrid cancellation filter 600, along with the digitized receive path signal u[k] from the RX signal path 530. For completeness, FIG. 6 also illustrates the Tx data path for the transceiver where user data to be transmitted is encoded by a modulator 660 (e.g., using IQ modulation) and converted to analog by DAC 662 for input into the Tx path 102, amplified by power amplifier 730, and wirelessly radiated by antenna 122.

As can be seen referring back to FIG. 1, the digitized reference signal y[k] is effectively a sampling of the Tx signal propagating through the Tx path 510. In the hybrid cancellation filter 600, the digitized reference signal y[k] is received into a digital filter 610. The digital filter 610 can be implemented by either a stand-alone filter, or a filter bank having a series or parallel configuration, to select the to-be-cancelled sub-bands. As used herein, the index value k represents the time discrete sample index of the digital signals k∈N∧n>0. The digitized Rx signal u[k] output from ADC 535 is fed into the digital filter 640, which can also be implemented either as a stand-alone filter, or a filter bank having a series or parallel configuration.

The filtered digitized reference signal y[k] and digitized receive path signal u[k] are input by an adaptive algorithm 630 to determine the coefficients of an adaptive filter 620 that will minimize errors between y[k] and u[k]. The adaptive algorithm 630 can comprise, but is not limited to, a least-mean-square, a normalized least-mean-square or a recursive least square filter, whichever is the best fit for the actual application.

The filtered reference signal y[k] is convolved with the adaptive filter 620 and afterwards the filter output signal \hat{x}[k] is converted to analog by DAC 525. This analog signal defines the hybrid cancellation signal 521 that is fed into the RX signal path 530 via the directional coupler 532 as described above.

The adaptive algorithm 630 optimizes the filter coefficients of the adaptive filter 620 so that the adaptive filter 620 models the Tx leakage portion in the Rx signal u[k] but does not impact the desired Rx signal portion since both are uncorrelated. The output signal of the adaptive filter \hat{x}[k] therefor represents the complex conjugate of the to-be-cancelled Tx leakage in the Rx signal u[k]. Because the hybrid cancellation signal 521 is fed back into the RX signal path 530, it destructively interferes with the initial Tx leakage and hence cancels it out. The phase shifters 514, 524 and attenuators 513, 523 are dynamically adjustable by the processing unit 108 to maintain destructive interference between the hybrid cancellation signal 521 and the Tx leakage portion in the received RF signal 142. Such adjustments may be made in response to varying or extreme temperature measurements as measured by sensor 107. As shown in FIG. 6, the Rx signal u[k] may be fed into the digital filter 664 to attenuate remaining noise before decoding by demodulator 668 (e.g., using IQ modulation) to produce baseband user data. Digital filter 664 is used to further isolate the desired Rx sub-bands from the sampled and modified Rx spectrum including residual Tx leakage which adds further margin on the Tx to Rx isolation.

In some cases, multiple Tx leakage signals may need to be mitigated due to multiple Tx transmission paths, for example, for multiple-input multiple-output (MIMO) systems. These additional leakage signals can be minimized by the hybrid cancellation filter 600 by utilizing further adaptive filters 621 and adaptive algorithms 631. In FIG. 6, the index value m represents the number of the alternate Tx chains in the communication system m∈N∧n>0.

In other embodiments, hybrid cancellation signals to compensate for more than one Tx path may be utilized. For example, in FIG. 5, and additional (optional) Aux DAC path 540 may be included and coupled to a directional coupler 548 to insert into the received RF signal 142 a second hybrid cancellation signal 541 produced by a second hybrid cancellation filter 600. Aux DAC path 540 comprises an attenuator 542, phase shifter 544, and DAC 546 that function as there equivalent counterparts of Aux DAC path 520. Aux DAC path 540 receives a digitized hybrid cancellation signal \hat{x}[k] from a hybrid cancellation filter 600 and outputs the hybrid cancellation signal 541 to the Rx ADC path 530.

In another embodiment, the Aux DAC path 540 may optionally replace the Aux DAC path 520. That is, the hybrid cancellation signal \hat{x}[k] produced by the hybrid cancellation filter 600 can be applied to directional coupler 548 in place of directional coupler 532.

It should be noted that the signal processing can be done in a remotely located processing unit 108 or by a processing unit 108 in the RF frontend itself using, for example, a loop-back in the transceiver IC, an external loop-back circuit or other signal processing methods.

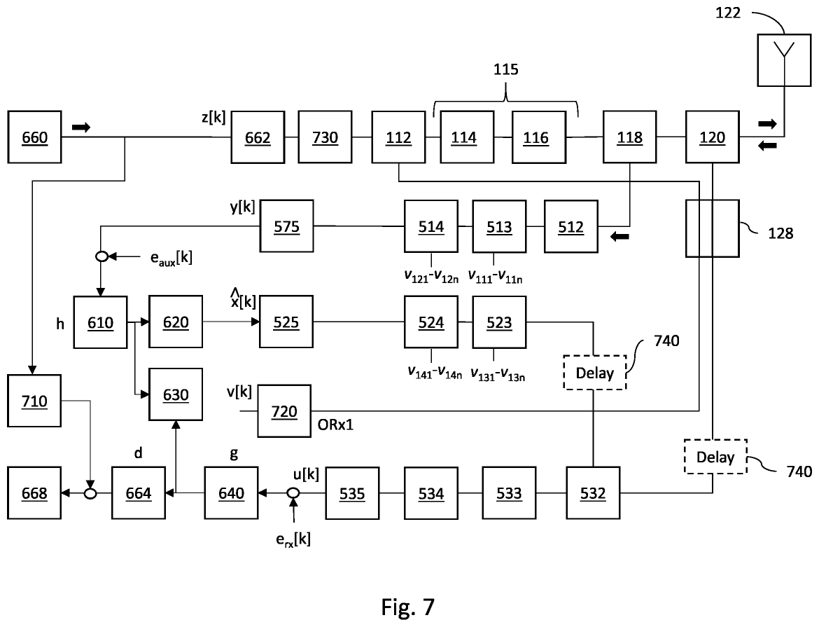

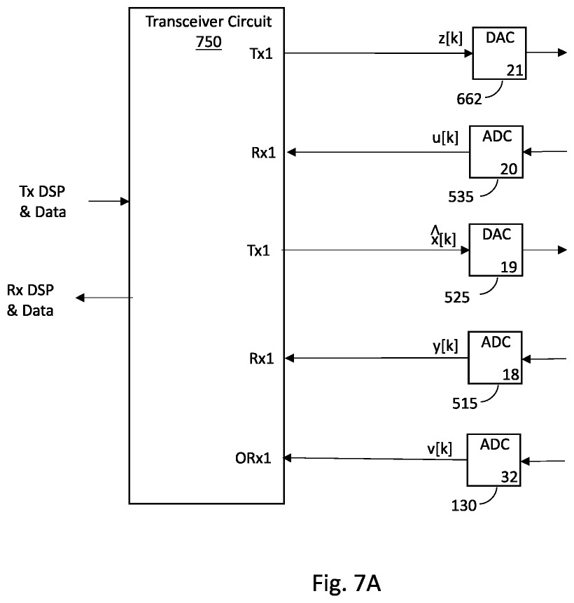

FIG. 7 is a diagram illustrating an example integration of a hybrid cancellation filter 600 stage with a precancellation circuit 100 stage. Although both the precancellation circuit 100 and the hybrid cancellation filter 600 can be independently implemented to improve isolation of a neutral host TDD transceiver Rx path from Tx signal leakage, their combined usage provides even further isolation for a neutral host TDD transceiver with independent UL/DL switch points.

In some embodiments, in order to synchronize time delay between different paths, one or more fixed and/or adjustable delay elements may be included. For example, FIG. 7 illustrates an optional fixed and/or adjustable delay element 740 positioned between the Rx RF signal output of the directional coupler 128 and the directional coupler 532 that applies the hybrid cancellation signal 521 to the Rx RF signal. Similarly an optional adjustable delay element 740 may also (or instead) be positioned in the Aux DAC path 520 between the Aux DAC 525 and the directional coupler 532. Where an optional Aux DAC path 540 is present, an optional adjustable delay element 740 may also (or instead) be positioned in that path between the DAC 546 and directional coupler 548.

In some implementations of this embodiment, the ADCs and DACs can be assigned to the ports of an integrated transceiver circuit located in the RF frontend (for example, the ADVR902x or ‘Madura’ family of RF transceiver devices from Analog Devices) family. Such a transceiver circuit is shown at 750 in FIG. 7A. The primary Tx DAC 662 and the Rx ADC 535 are connected to Tx1 and Rx1 ports of the transceiver circuit 750. The ADC 515 and DAC 525 are used for the hybrid main canceller map to Tx2 and Rx2 of the transceiver circuit 750. For embodiments where an observation receiver is optionally utilized (discussed below), an observation receiver ADC 130 may be connected to an observation receiver (ORx1) input to the transceiver circuit 750.

In some embodiments, the digital signal processing reformed by the transceiver circuit 750 may be distributed onto a remotely placed processing unit 108 (for example, located on a baseband board).

The processing unit 108 may further implement an optional digital canceller 710 to eliminate the residual Tx leakage after the hybrid cancellation filter 600 and precancellation circuit 100 cancellation stages upstream in the Rx path. The additional digital canceller 710 can use, but is not limited to, an artificial intelligence algorithm, an adaptive filter or a basic polynomial model. The digital canceller 710 further modifies the digital Rx signal in a way that it interferes destructively with the Tx leakage portion in the residual digital Rx signal after superposition of the hybrid main canceller 600 in the analog domain. For realization of a 2×2 MIMO system the additional Rx and Tx chains of transceiver circuit 750 may be used similarly using a second adaptive filter stage to eliminate Tx leakage from the alternate MIMO paths.

An observation receiver ADC 720 may be optionally connected to port 4 of the directional coupler 128. The output from this port of the directional coupler 128 can be used by the processing unit 108 to measure the reflected waves from the antenna 122 and can be utilized for several purposes. For example this measurement may be used for self-calibration of the precancellation circuit 100 in production or during operation and measurement of reflection coefficients. The observation receiver may also be used in parallel as an observation receiver for a dynamic digital predistortion (DPD) engine for the transceiver transmit path. In some embodiments, the processing unit 108 can utilize the measurements from observation receiver ADC 720 for multiple purposes and switch (between an optional connection between 118 and 720 or 128 and 720) as needed.

Note that while the embodiments above disclose an antenna 122 for transmitting and receiving, these embodiments may alternately comprise separate antenna for transmitting and receiving. For example, the antenna circulator 120 may be omitted and a Tx antenna may be coupled directly circulator 118, with a Rx antenna coupled directly to the directional coupler 128.

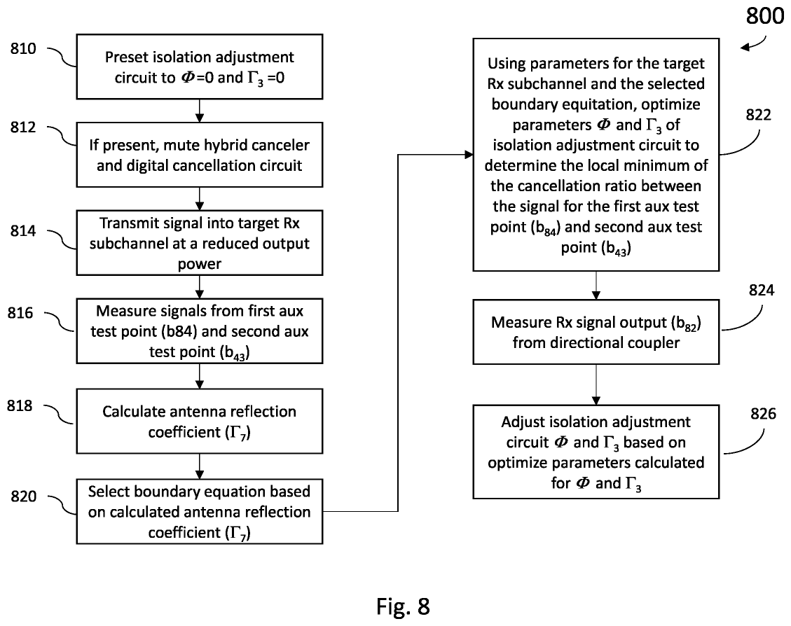

FIG. 8 is a flow chart illustrating a method 800 for calibrating a precancellation circuit such as the precancellation circuit 100 of FIG. 1. It should be understood that the features and elements described herein with respect to the method 800 shown in FIG. 8 and the accompanying description may be used in conjunction with, in combination with, or substituted for elements of any of the other embodiments discussed with respect to the other figures, or elsewhere herein, and vice versa. Further, it should be understood that the functions, structures and other description of elements associated with embodiments of FIG. 8 may apply to like named or described elements for any of the other figures and embodiments and vice versa.

The method begins at 810 where the phase of the phase shifter 114 is set to zero (Φ₂=0) and the reflection tuner 116 is set for a reflection coefficient of zero (Γ₃=0) and 812 where downstream cancellation stages, if present, are muted to not have an impact on the precancellation circuit 100. The method proceeds to 814 with transmitting a calibration signal through the Tx path 102 of the precancellation circuit 100 at the target isolation frequency (for example, the frequency of the Rx subchannel undergoing calibration). For example, to calibrate for isolation in the Rx path 104 at 3600 MHz, then the calibration signal would be at 3600 MHz. It would be understood that for calibration purposes, the calibration signal can be generated at a reduced power compared to TX signals that would carry communications when the system is in service.

The method proceeds to 816 with measuring the reflection coefficient Γ₇ presented by the antenna 122. For example, a first measurement of the reflected wave can be made from the output of port 3 of the antenna circulator 120, which can be measured by ADC 130 coupled to the port 4 of the directional coupler 128 (i.e., wave ‘b₈₄’). A second measurement of the forward travelling wave can be made from the output of port 3 of the Aux circulator 118, which can be measured by ADC 124 coupled to the port 3 of the Aux circulator 118 (i.e., wave ‘b₄₃’). Note, that at this point in the calibration, Φ₂=0 and Γ₃=0. This is followed by the fact that a₈₁C₈e^{-jπ} is much higher than the signal from circulator 112, a₁₁I₁L₈, so that b₈₄˜a₈₁C₈e^{-jπ} which in a first assumption directly relates to the wave portion being reflected at the antenna.

Utilizing these first and second measurements, the method proceeds to 818 with calculating the antenna 122 reflection coefficient, Γ₇. The antenna 122 reflection coefficient, Γ₇, can be calculated using the equation:

$${Γ}_{7} = \frac{{b}_{84}}{{b}_{42}} \frac{{I}_{4}^{2}}{{L}_{4} {L}_{5} {C}_{8} {e}^{- j π}}$$

where L₄, L₅ and C₈ are known values determined based on the target isolation frequency, for example from device datasheets, manufacturer supplied curves or tables, direct measurements, or from other sources.

The method then proceeds to 820 with selecting a boundary equation based on the calculated antenna 122 reflection coefficient, Γ₇. The boundary equations are the equations (1), (2.1) and (2.2) for the boundary condition discussed above (or equivalent equations thereof). For example, for Γ₇=0, the selected boundary equation would be Eq. (1), for Γ₇≠0, Γ₇≤C₈ the selected boundary equation would be Eq. (2.1), and for

$${Γ}_{7} \neq 0 , {Γ}_{7} = \frac{{I}_{5}^{*}}{{L}_{5}^{2}} \sim {I}_{5}^{*}$$

the selected boundary equation would be Eq. (2.2).

With knowledge of the value of Γ₇ and a boundary equation selected, the method proceeds to 822 with calculating the parameter Φ₂ for the phase shifter 114 and Γ₃ for the reflection tuner 116. In some implementations, these may be calculated by optimizing the parameters Φ₂ and Γ₃ to determine a local minimum of the cancellation ratio between the signal for the first measurement (b84) and the second measurement (b43). It should be noted that the nomenclature “cancellation” implies a negative sign which means the better the performance, the higher the logarithmic cancellation value. Calibration thus involves the search for a local maximum of the cancellation, but because the equations consider linear terms, the cancellation ratio is minimum in case where the cancellation becomes maximal.

The method proceeds to 824 with measuring the Rx signal output from the precancellation circuit 100 (which can be measured from the output signals b82 of the directional coupler 128) and to 826 with adjusting the Φ₂ setting for the phase shifter 114 and Γ₃ setting for the reflection tuner 116 based on the calculated Φ₂ and Γ₃ values. In some embodiments, the calculated Φ₂ and Γ₃ values may provide an initial setpoint which can then be varied while measuring the Rx signal output to find a point of maximum isolation.

The final Φ₂ and Γ₃ setpoint values may then be stored in memory 109 (for example in a look-up table) as setpoint corresponding to the target isolation frequency and/or Rx sub-band. This process can be repeated for the target isolation frequency for each Rx sub-band, and for each combination of Rx sub-bands. That is, after storing the optimal Φ₂ and Γ₃ settings in the memory 109, the next sub-band configuration is calibrated. The calibration is repeated for all possible sub-band setups, and the thereby determined presets are stored in the processing unit for all 2ₘ sub-band configurations. For example, where the neutral host transceiver support 4 sub-bands, there may be up to 16 sets of Φ₂ and Γ₃ setpoint values stored in memory 109 for each of the possible combinations of subchannels operating in either Tx or Rx mode. Then during runtime operation, based on which sub-band is in Tx mode, and which is in Rx mode, the processing unit 108 selects from memory the Φ₂ and Γ₃ setpoint values that correlate to that Tx/Rx mode configuration and loads those setpoint into the isolation adjustment circuit 115.

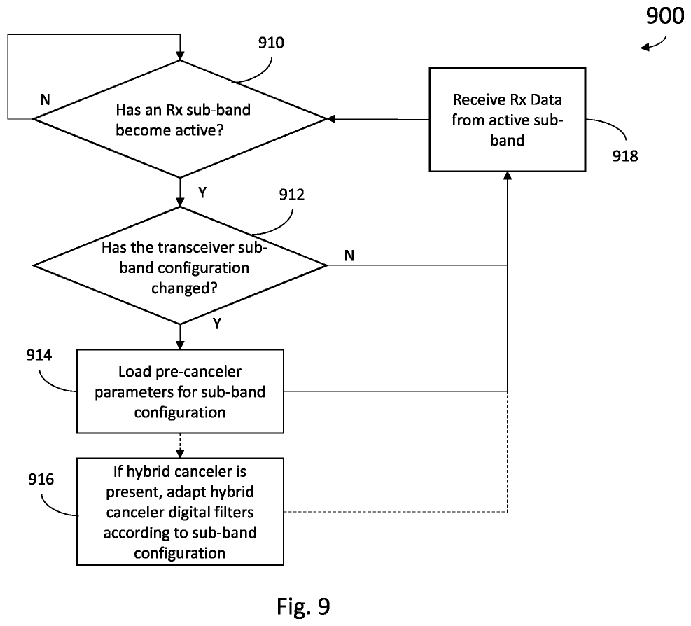

FIG. 9 is a flow chart illustrating an example of one such method 900. It should be understood that the features and elements described herein with respect to the method 900 shown in FIG. 9 and the accompanying description may be used in conjunction with, in combination with, or substituted for elements of any of the other embodiments discussed with respect to the other figures, or elsewhere herein, and vice versa. Further, it should be understood that the functions, structures and other description of elements associated with embodiments of FIG. 8 may apply to like named or described elements for any of the other figures and embodiments and vice versa.

During operation in the field, the processing unit 108 is aware of current sub-band configuration state although the band assignment can dynamically change over time. Therefore, it has information to determine if a sub-band is in Rx or Tx mode and can adjust the Φ₂ and Γ₃ setpoint values so that the precancellation circuit 100 provided sufficient Tx to Rx suppression for a neutral host transceiver, even with unsynchronized UL/DL switch points. The method begins at 910 with determining if a Rx sub-band has become active. That is, the processing unit 108 determine if one of the sub-bands of the transceiver is actively receiving an RF signal. The method proceeds to 912 with determining if the transceiver sub-band configuration has changed. If not, then the current Φ₂ and Γ₃ setpoint values are still valid and effective and the method can proceed to 918 with receiving an RF signal on the active sub-band. If the transceiver sub-band configuration has changed since last actively receiving an RF signal, then the method proceeds to 914 with loading the precancellation circuit 100 with the Φ₂ and Γ₃ setpoint values for the current sub-band configuration. In some embodiments, the processing unit 108 correlates the current sub-band configuration to Φ₂ and Γ₃ setpoint values based on a look-up table in memory 109. The method then proceed to 918 with receiving an RF signal on the active sub-band.

The information regarding sub-band configuration can also be used to switch or configure the different digital filter banks 610, 640 and 664 hybrid cancellation filter 600. That is, the pass-band of these digital filters can be configured based on the sub-band configuration and particularly the frequencies of the one or more channels in Rx mode. As such, the method 900 can optionally also proceed to 916 where, if the hybrid cancellation filter 600 is present, adapting one or more digital filters of the hybrid cancellation filter 600 according to the present sub-band configuration.

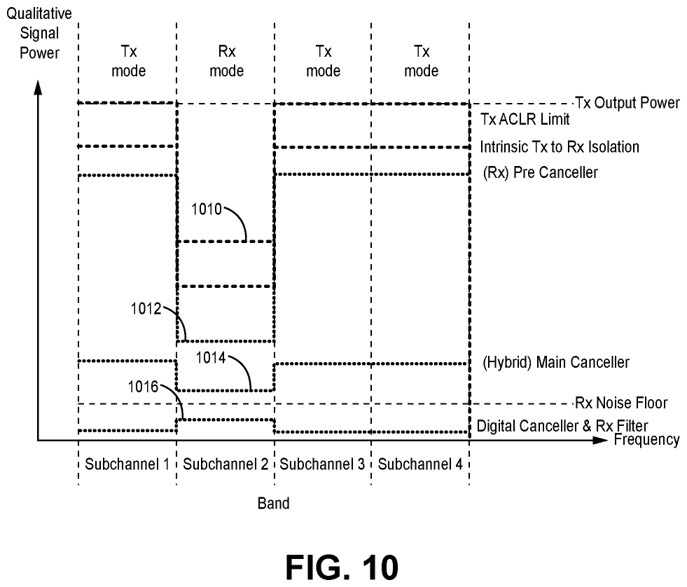

FIG. 10 is a graph depicting power verses subchannel (frequency) for an example RF band comprising four subchannels (sub-bands). The figure shows a qualitative view of the Tx and Rx signal levels which are corresponding to the leakage signal suppression and demonstrates thereby the successive desensitization improvement in each stage. In this example, subchannels 1, 3 and 4 are operating in transmit (Tx) mode, with subchannel 2 in receive (Rx) mode. The Tx output power for subchannels 1, 3 and 4 is shown by plot 1010. Without any of the isolation stages discussed herein, the resulting leakage signal measurable in subchannel 2 as shown by plot 1010 is attenuated by about 45 dB in accordance with the ACLR. The precancellation circuit 100 provides additional isolation in subchannel 2 as shown by plot 1012, where the Φ₂ and Γ₃ setpoint values for the isolation adjustment circuit 115 have been optimized for the center frequency of subchannel 2 as discussed above. In this example, only subchannel 2 is shown as operating in Rx mode with subchannels 1, 3 and 4 in Tx mode. However, at other times, more than one subchannel may be in Rx mode concurrently. For that subchannel configuration, the Φ₂ and Γ₃ setpoint values would be selected to optimize for the best achievable isolation in the Rx mode subchannels. The hybrid cancellation filter 600, when included, provides additional isolation in subchannel 2 as shown by plot 1014, where the leakage from the Tx mode channels is only just above the Rx path noise floor. Finally, the optional digital canceller 710 pushed the remaining qualitative signal power due to Tx signal leakage below the Rx path noise floor as shown by plot 1016.

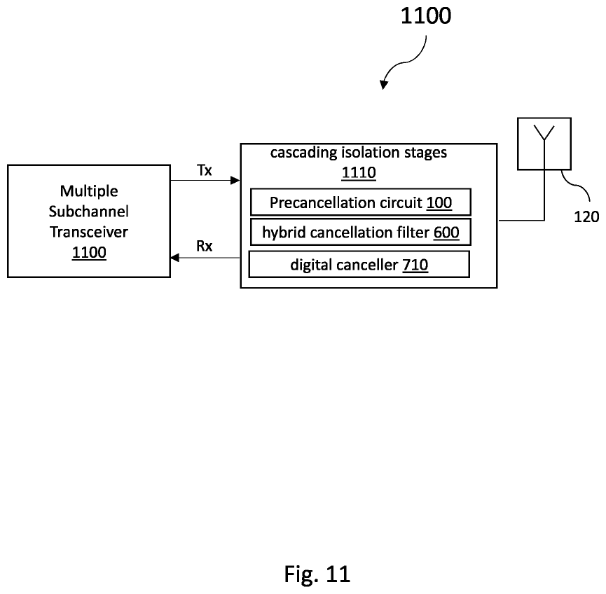

Although this disclosure has specifically mentioned implementation of leakage signal suppression for neutral-host base stations, it should be understood that the embodiments described herein may be applied to achieve leakage signal suppression in other forms of multiple-subchannel wireless transceivers (such as where multiple MNOs are sharing the network communication hardware). This general embodiment is illustrated in FIG. 11 where a multiple-subchannel wireless transceiver 1100 has its Tx and Rx signal paths coupled to cascading isolation stages 1110 that may comprise one or more of the precancellation circuit 100, hybrid cancellation filter 600 and/or digital canceller 710 to isolate the subchannels actively receiving in Rx mode from Tx signal leakage of from subchannels actively transmitting in Tx mode. Here, the multiple-subchannel wireless transceiver 1100 and cascading isolation stages 1110 may be components of a multiple-subchannel wireless base station. For example, the subchannel wireless transceiver 1100 and cascading isolation stages 1110 may be elements of a radio unit (RU) coupled to a baseband unit (BBU). Alternatively, the subchannel wireless transceiver 1100 and cascading isolation stages 1110 may be elements of distributed antenna system (DAS) comprising a master unit (MU) coupled to a plurality of remote antenna units (RAUs). In various implementations of DAS embodiments, the cascading isolation stages 1110 may be comprises either with the MU or the RAUs. The subchannel wireless transceiver 1100 and cascading isolation stages 1110 may be elements of an off-air repeater. One implementation such an off-air repeater could comprise a first set of a subchannel wireless transceiver 1100 and cascading isolation stage 1110 for the donor antenna side of the repeater, and a second set of a subchannel wireless transceiver 1100 and cascading isolation stage 1110 for the coverage antenna side of the repeater.

### EXAMPLE EMBODIMENTS

Example 1 includes an isolation circuit for a multiple-subchannel wireless communication transceiver, the isolation circuit comprising: a transmit (Tx) path coupled to a transmit path output of a multiple-subchannel transceiver; a receive (Rx) path coupled to a receive path input of the multiple-subchannel transceiver; a precancellation circuit comprising: an isolation adjustment circuit comprised within the transmit path of the isolation circuit, the isolation adjustment circuit comprising a phase shifter and a reflection tuner; a directional coupler comprised within the Rx path of the isolation circuit; wherein the isolation adjustment circuit outputs a reflected wave signal comprising a cancellation reference signal to the directional coupler, wherein the cancellation reference signal comprises a complex conjugate of a TX signal leakage signal component of a received RF signal transported in the Rx path of the isolation circuit, wherein within the directional coupler the cancellation reference signal destructively interferes with TX signal leakage signal component.

Example 2 includes the isolation circuit of Example 1, further comprising: a first circulator coupled between the transmit path output and the isolation adjustment circuit, the first circulator configured to receive the cancellation reference signal from the isolation adjustment circuit and output the cancellation reference signal to the directional coupler.

Example 3 includes the isolation circuit of any of Examples 1-2, further comprising: an aux circulator having a first port coupled to the isolation adjustment circuit, a second port coupled, either directly or indirectly, to an antenna, and a third port that outputs a signal representative of a reflection coefficient of the antenna.

Example 4 includes the isolation circuit of any of Examples 1-3, further comprising: an antenna circulator having a first port coupled, either directly or indirectly, to the isolation adjustment circuit, a second port coupled to an antenna, and a third port coupled to the directional coupler, wherein the antenna circulator outputs the received RF signal comprising the TX signal leakage signal component to the directional coupler.

Example 5 includes the isolation circuit of any of Examples 1-4, where the isolation adjustment circuit comprises an adjustable phase (Φ) setting and an adjustable reflection coefficient (Γ) setting to adjust the cancellation reference signal.

Example 6 includes the isolation circuit of Example 5, further comprising: a processor coupled to a memory; wherein the adjustable phase (Φ) setting and the adjustable reflection coefficient (Γ) setting are controllable by the processor.

Example 7 includes the isolation circuit of Example 6, wherein the memory includes a look-up table comprising a plurality of setting sets that each include a phase setting and a reflection coefficient setting, wherein each setting set is associated with a subchannel mode configuration; wherein the processor loads into the isolation adjustment circuit a selected setting set based on a current subchannel mode configuration.

Example 8 includes the isolation circuit of any of Examples 6-7, wherein the processor adjusts control voltages to control the phase setting and the reflection coefficient setting.

Example 9 includes the isolation circuit of any of Examples 6-8, further comprising a temperature sensor, wherein the processor further adjusts the phase setting and the reflection coefficient setting based on a temperature measurement from the temperature sensor.

Example 10 includes the isolation circuit of any of Examples 1-9, further comprising: a hybrid cancellation filter coupled to an output of the directional coupler to receive an Rx path signal, the hybrid cancellation filter further coupled to the Tx path between the isolation adjustment circuit and an antenna port to receive a Tx path reference signal; the hybrid cancellation filter comprising: one or more digital filters; at least one adaptive algorithm executed by a processor coupled to a memory; and at least one adaptive filter coupled to the first digital filter; wherein the hybrid cancellation filter digitizes the reference signal; wherein a first digital filter outputs a filtered reference signal based on a subchannel mode configuration of the multiple-subchannel wireless communication transceiver as determined by the processor; wherein the at least one adaptive algorithm determines filter coefficients for the adaptive filter based on the Rx path signal; wherein the filtered reference signal is convolved with the at least one adaptive filter and converted to analog to produce a hybrid cancellation signal; wherein the hybrid cancellation signal is coupled back into the Rx path and destructively interferes with the TX signal leakage signal component.

Example 11 includes the isolation circuit of Example 10, wherein a second digital filter filters the Rx path signal prior to input to the at least one adaptive algorithm, based on the subchannel mode configuration of the multiple-subchannel wireless communication transceiver as determined by the processor; wherein a third digital filter filters the Rx path signal prior to output from the hybrid cancellation filter, based on the subchannel mode configuration of the multiple-subchannel wireless communication transceiver as determined by the processor.

Example 12 includes the isolation circuit of any of Examples 10-11, wherein filter settings for the one or more digital filters are stored in the memory

wherein each filter setting is associated with a subchannel mode configuration; wherein the processor adjusts a passband of the one or more digital filters based on a current subchannel mode configuration.

Example 13 includes the isolation circuit of any of Examples 10-12, further comprising an interface circuit configured to couple the hybrid cancellation filter to the precancellation circuit, the interface. circuit configured to adjust a signal leveling of the reference signal and the hybrid cancellation signal.

Example 14 includes the isolation circuit of Example 13, wherein the interface circuit comprises a plurality of phase shifters and attenuators controllable by the processor to adjust the signal leveling.

Example 15 includes the isolation circuit of any of Examples 10-14, further comprising a digital canceller coupled between the Tx path and the Rx path and configured to apply a signal to the Rx path to destructively interfere with the Tx signal leakage signal component after the hybrid cancellation signal is coupled back into the Rx path.

Example 16 includes the isolation circuit of any of Examples 10-15, further comprising at least one of: a delay element between an output of the directional coupler and the hybrid cancellation filter to adjust a delay the Rx path signal, or a delay element to adjust a delay the hybrid cancellation signal from the hybrid cancellation filter.

Example 17 includes an isolation circuit for a multiple-subchannel wireless communication transceiver, the isolation circuit comprising: a transmit (Tx) path coupled to a transmit path output of a multiple-subchannel transceiver; a receive (Rx) path coupled to a receive path input of the multiple-subchannel transceiver; a hybrid cancellation filter coupled to the Rx path to receive an Rx path signal, the hybrid cancellation filter further coupled to the Tx path to receive a Tx path reference signal; the hybrid cancellation filter comprising: one or more digital filters; at least one adaptive algorithm executed by a processor coupled to a memory; and at least one adaptive filter coupled to the first digital filter; wherein the hybrid cancellation filter digitizes the reference signal; wherein a first digital filter outputs a filtered reference signal based on a subchannel mode configuration of the multiple-subchannel wireless communication transceiver as determined by the processor; wherein the at least one adaptive algorithm determines filter coefficients for the adaptive filter based on the Rx path signal; wherein the filtered reference signal is convolved with the at least one adaptive filter and converted to analog to produce a hybrid cancellation signal; wherein the hybrid cancellation signal is coupled back into the Rx path and destructively interferes with the TX signal leakage signal component.

Example 18 includes the isolation circuit of Example 17, wherein a second digital filter filters the Rx path signal prior to input to the at least one adaptive algorithm, based on the subchannel mode configuration of the multiple-subchannel wireless communication transceiver as determined by the processor; wherein a third digital filter filters the Rx path signal prior to output from the hybrid cancellation filter, based on the subchannel mode configuration of the multiple-subchannel wireless communication transceiver as determined by the processor.

Example 19 includes the isolation circuit of any of Examples 17-18, wherein filter settings for the one or more digital filters are stored in the memory; wherein each filter setting is associated with a subchannel mode configuration; and wherein the processor adjusts a passband of the one or more digital filters based on a current subchannel mode configuration.

Example 20 includes the isolation circuit of any of Examples 17-19, further comprising a digital canceller coupled between the Tx path and the Rx path and configured to apply a signal to the Rx path to destructively interfere with the Tx signal leakage signal component after the hybrid cancellation signal is coupled back into the Rx path.

Example 21 includes the isolation circuit of any of Examples 17-20, further comprising at least one of: a delay element between in the Rx path to adjust a delay the Rx path signal, or

a delay element to adjust a delay the hybrid cancellation signal from the hybrid cancellation filter.

Example 22 includes a wireless transceiver system, the wireless transceiver system comprising: a multiple-subchannel wireless transceiver comprising a transmit (Tx) signal path and a receive (Rx) signal path; one or more cascading isolation stages coupled between the multiple-subchannel wireless transceiver and one or more antenna, the one or more cascading isolation stages comprising one or more or a precancellation circuit, a hybrid cancellation filter or a digital canceller as in any of Examples 1-Example 21.

Example 23 includes the wireless transceiver system of Example 22, wherein the wireless transceiver system comprises one of: a wireless network base station; a distributed antenna system; or an off-air repeater system.

Example 24 includes a method for signal path isolation for neutral-host hardware, the method comprising: determining when at least one subchannel is active on a receive path of a multiple-subchannel receiver; determining when a subchannel configuration of the multiple-subchannel receiver has changed; when at least one subchannel is active on a receive path and the subchannel configuration has changed, adjusting at least one of a phase (Φ) setting and a reflection coefficient (Γ) setting of an isolation adjustment circuit to adjust a cancellation reference signal according to a current subchannel configuration; wherein the cancellation reference signal comprises a complex conjugate of a transmit signal leakage signal component of a received RF signal transported in the received path, wherein the cancellation reference signal destructively interferes with transmit signal leakage signal component.

Example 25 includes the method of Example 24, further comprising: reading the phase (Φ) setting and the reflection coefficient (Γ) setting from a reference table based on the current subchannel configuration; and loading the phase (Φ) setting and the reflection coefficient (Γ) setting into the isolation adjustment circuit.

Example 26 includes the method of any of Examples 24-25, further comprising: adjusting one or more digital filters of a hybrid cancellation filter according to the current subchannel configuration; utilizing an adaptive algorithm to determine the coefficients of an adaptive filter based on the received RF signal; and generating a hybrid cancellation signal from an output of the adaptive filter; wherein the hybrid cancellation signal destructively interferes with transmit signal leakage signal component.

In various alternative embodiments, system and/or device elements, method steps, or example implementations described throughout this disclosure (such as any of the precancellation circuit, hybrid cancellation filter, digital canceller, digital filters, adaptive algorithm, adaptive filter, cascading isolation stages, transceiver circuit, multiple subchannel, transceiver, phase shifters, attenuators, reflection tuner, base station, radio units, distributed antenna systems, master unit, remote antenna units, controllers, processor, memory, or sub-parts thereof, for example) may be implemented at least in part using one or more computer systems, field programmable gate arrays (FPGAs), or similar devices comprising a processor coupled to a memory and executing code to realize those elements, processes, or examples, said code stored on a non-transient hardware data storage device. Therefore, other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

As used herein, wireless base station related terms such as precancellation circuit, hybrid cancellation filter, digital canceller, digital filters, adaptive algorithm, adaptive filter, cascading isolation stages, transceiver circuit, multiple subchannel, transceiver, phase shifters, attenuators, reflection tuner, base station, radio units, distributed antenna systems, master unit, remote antenna units, controllers, processor, memory, or sub-parts thereof, refer to non-generic elements as would recognized and understood by those of skill in the art of telecommunications and networks and are not used herein as nonce words or nonce terms for the purpose of invoking 35 USC 112(f).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. An isolation circuit for a multiple-subchannel wireless communication transceiver, the isolation circuit comprising:
a transmit (Tx) path coupled to a transmit path output of a multiple-subchannel transceiver;
a receive (Rx) path coupled to a receive path input of the multiple-subchannel transceiver;
a precancellation circuit comprising:
an isolation adjustment circuit comprised within the transmit path of the isolation circuit, the isolation adjustment circuit comprising a phase shifter and a reflection tuner;
a directional coupler comprised within the Rx path of the isolation circuit;
wherein the isolation adjustment circuit outputs a reflected wave signal comprising a cancellation reference signal to the directional coupler, wherein the cancellation reference signal comprises a complex conjugate of a TX signal leakage signal component of a received RF signal transported in the Rx path of the isolation circuit, wherein within the directional coupler the cancellation reference signal destructively interferes with TX signal leakage signal component.

2. The isolation circuit of claim 1, further comprising:
a first circulator coupled between the transmit path output and the isolation adjustment circuit, the first circulator configured to receive the cancellation reference signal from the isolation adjustment circuit and output the cancellation reference signal to the directional coupler.

3. The isolation circuit of claim 1, further comprising:
an aux circulator having a first port coupled to the isolation adjustment circuit, a second port coupled, either directly or indirectly, to an antenna, and a third port that outputs a signal representative of a reflection coefficient of the antenna.

4. The isolation circuit of claim 1, further comprising:
an antenna circulator having a first port coupled, either directly or indirectly, to the isolation adjustment circuit, a second port coupled to an antenna, and a third port coupled to the directional coupler, wherein the antenna circulator outputs the received RF signal comprising the TX signal leakage signal component to the directional coupler.

5. The isolation circuit of claim 1, where the isolation adjustment circuit comprises an adjustable phase (Φ) setting and an adjustable reflection coefficient (Γ) setting to adjust the cancellation reference signal.

6. The isolation circuit of claim 5, further comprising:
a processor coupled to a memory;
wherein the adjustable phase (Φ) setting and the adjustable reflection coefficient (Γ) setting are controllable by the processor.

7. The isolation circuit of claim 6, wherein the memory includes a look-up table comprising a plurality of setting sets that each include a phase setting and a reflection coefficient setting, wherein each setting set is associated with a subchannel mode configuration;
wherein the processor loads into the isolation adjustment circuit a selected setting set based on a current subchannel mode configuration.

8. The isolation circuit of claim 6, wherein the processor adjusts control voltages to control the phase setting and the reflection coefficient setting.

9. The isolation circuit of claim 6, further comprising a temperature sensor, wherein the processor further adjusts the phase setting and the reflection coefficient setting based on a temperature measurement from the temperature sensor.

10. The isolation circuit of claim 1, further comprising:
a hybrid cancellation filter coupled to an output of the directional coupler to receive an Rx path signal, the hybrid cancellation filter further coupled to the Tx path between the isolation adjustment circuit and an antenna port to receive a Tx path reference signal;
the hybrid cancellation filter comprising:
one or more digital filters;
at least one adaptive algorithm executed by a processor coupled to a memory; and
at least one adaptive filter coupled to the first digital filter;
wherein the hybrid cancellation filter digitizes the reference signal;
wherein a first digital filter outputs a filtered reference signal based on a subchannel mode configuration of the multiple-subchannel wireless communication transceiver as determined by the processor;
wherein the at least one adaptive algorithm determines filter coefficients for the adaptive filter based on the Rx path signal;
wherein the filtered reference signal is convolved with the at least one adaptive filter and converted to analog to produce a hybrid cancellation signal;
wherein the hybrid cancellation signal is coupled back into the Rx path and destructively interferes with the TX signal leakage signal component.

11. The isolation circuit of claim 10, wherein a second digital filter filters the Rx path signal prior to input to the at least one adaptive algorithm, based on the subchannel mode configuration of the multiple-subchannel wireless communication transceiver as determined by the processor;
wherein a third digital filter filters the Rx path signal prior to output from the hybrid cancellation filter, based on the subchannel mode configuration of the multiple-subchannel wireless communication transceiver as determined by the processor.

12. The isolation circuit of claim 10, wherein filter settings for the one or more digital filters are stored in the memory
wherein each filter setting is associated with a subchannel mode configuration;
wherein the processor adjusts a passband of the one or more digital filters based on a current subchannel mode configuration.

13. The isolation circuit of claim 10, further comprising an interface circuit configured to couple the hybrid cancellation filter to the precancellation circuit, the interface. circuit configured to adjust a signal leveling of the reference signal and the hybrid cancellation signal.

14. The isolation circuit of claim 13, wherein the interface circuit comprises a plurality of phase shifters and attenuators controllable by the processor to adjust the signal leveling.

15. The isolation circuit of claim 10, further comprising a digital canceller coupled between the Tx path and the Rx path and configured to apply a signal to the Rx path to destructively interfere with the Tx signal leakage signal component after the hybrid cancellation signal is coupled back into the Rx path.

16. The isolation circuit of claim 10, further comprising at least one of:
a delay element between an output of the directional coupler and the hybrid cancellation filter to adjust a delay the Rx path signal, or
a delay element to adjust a delay the hybrid cancellation signal from the hybrid cancellation filter.

17. An isolation circuit for a multiple-subchannel wireless communication transceiver, the isolation circuit comprising:
a transmit (Tx) path coupled to a transmit path output of a multiple-subchannel transceiver;
a receive (Rx) path coupled to a receive path input of the multiple-subchannel transceiver;
a hybrid cancellation filter coupled to the Rx path to receive an Rx path signal, the hybrid cancellation filter further coupled to the Tx path to receive a Tx path reference signal;
the hybrid cancellation filter comprising:
one or more digital filters;
at least one adaptive algorithm executed by a processor coupled to a memory; and
at least one adaptive filter coupled to the first digital filter;
wherein the hybrid cancellation filter digitizes the reference signal;
wherein a first digital filter outputs a filtered reference signal based on a subchannel mode configuration of the multiple-subchannel wireless communication transceiver as determined by the processor;
wherein the at least one adaptive algorithm determines filter coefficients for the adaptive filter based on the Rx path signal;
wherein the filtered reference signal is convolved with the at least one adaptive filter and converted to analog to produce a hybrid cancellation signal;
wherein the hybrid cancellation signal is coupled back into the Rx path and destructively interferes with the TX signal leakage signal component.

18. The isolation circuit of claim 17, wherein a second digital filter filters the Rx path signal prior to input to the at least one adaptive algorithm, based on the subchannel mode configuration of the multiple-subchannel wireless communication transceiver as determined by the processor;
wherein a third digital filter filters the Rx path signal prior to output from the hybrid cancellation filter, based on the subchannel mode configuration of the multiple-subchannel wireless communication transceiver as determined by the processor.

19. The isolation circuit of claim 17, wherein filter settings for the one or more digital filters are stored in the memory;
wherein each filter setting is associated with a subchannel mode configuration; and
wherein the processor adjusts a passband of the one or more digital filters based on a current subchannel mode configuration.

20. The isolation circuit of claim 17, further comprising a digital canceller coupled between the Tx path and the Rx path and configured to apply a signal to the Rx path to destructively interfere with the Tx signal leakage signal component after the hybrid cancellation signal is coupled back into the Rx path.

21. The isolation circuit of claim 17, further comprising at least one of:
a delay element between in the Rx path to adjust a delay the Rx path signal, or
a delay element to adjust a delay the hybrid cancellation signal from the hybrid cancellation filter.

22. A wireless transceiver system, the wireless transceiver system comprising:
a multiple-subchannel wireless transceiver comprising a transmit (Tx) signal path and a receive (Rx) signal path;
one or more cascading isolation stages coupled between the multiple-subchannel wireless transceiver and one or more antenna, the one or more cascading isolation stages comprising one or more or a precancellation circuit, a hybrid cancellation filter or a digital canceller as in any of claims 1-21.

23. The wireless transceiver system of claim 22, wherein the wireless transceiver system comprises one of:
a wireless network base station;
a distributed antenna system; or
an off-air repeater system.

24. A method for signal path isolation for neutral-host hardware, the method comprising:
determining when at least one subchannel is active on a receive path of a multiple-subchannel receiver;
determining when a subchannel configuration of the multiple-subchannel receiver has changed;
when at least one subchannel is active on a receive path and the subchannel configuration has changed, adjusting at least one of a phase (Φ) setting and a reflection coefficient (Γ) setting of an isolation adjustment circuit to adjust a cancellation reference signal according to a current subchannel configuration;
wherein the cancellation reference signal comprises a complex conjugate of a transmit signal leakage signal component of a received RF signal transported in the received path, wherein the cancellation reference signal destructively interferes with transmit signal leakage signal component.

25. The method of claim 24, further comprising:
reading the phase (Φ) setting and the reflection coefficient (Γ) setting from a reference table based on the current subchannel configuration; and
loading the phase (Φ) setting and the reflection coefficient (Γ) setting into the isolation adjustment circuit.

26. The method of claim 24, further comprising:
adjusting one or more digital filters of a hybrid cancellation filter according to the current subchannel configuration;
utilizing an adaptive algorithm to determine the coefficients of an adaptive filter based on the received RF signal; and
generating a hybrid cancellation signal from an output of the adaptive filter;
wherein the hybrid cancellation signal destructively interferes with transmit signal leakage signal component.
